(19) United States
(12) Patent Application Publication
(10) Pub. No.: US 2025/0013072 A1
(43) Pub. Date: Jan. 9, 2025

(54) EYEWEAR SYSTEM WITH REPLACEABLE LENSES

(71) Applicants: Eric Rhea, Cumberland, RI (US); Matthew Henri Coon, New York, NY (US)

(72) Inventors: Eric Rhea, Cumberland, RI (US); Matthew Henri Coon, New York, NY (US)

(21) Appl. No.: 18/894,332

(22) Filed: Sep. 24, 2024

Related U.S. Application Data
(63) Continuation-in-part of application No. 18/391,386, filed on Dec. 20, 2023.
(60) Provisional application No. 63/625,106, filed on Jan. 25, 2024.

(30) Foreign Application Priority Data
Apr. 23, 2023 (CN) 202320958051

(51) Int. Cl. G02C 1/06; G02C 5/12

(52) U.S. Cl. CPC G02C 1/06; G02C 5/12

(57) ABSTRACT

An eyewear system includes a base and a plurality of lens inserts which are dimensioned and configured to be releasably retained by the base, and removable from the base without tools. The base may be at least partially recessed on a rear face to accommodate a lens insert. The lens insert may include a lens and a subframe, the subframe being configured to nestle within the recess of the base.

### CLAIM OF PRIORITY

The present Non-Provisional patent application claims priority pursuant to 35 U.S.C. Section 119 (e) to a currently pending and prior filed Provisional patent application, namely, that having Ser. No. 63/625,106 filed on Jan. 25, 2024. This application also claims the domestic benefit, pursuant to 35 U.S.C. § 102, and is a continuation-in-part application of previously filed U.S. patent application having Ser. No. 18/391,386 and a filing date of Dec. 20, 2023, which claimed priority to Chinese Patent Application Serial No. 202320958051 filed on Apr. 23, 2023. The contents of each of the above are incorporated herein in their entireties by reference.

### BACKGROUND OF THE INVENTION

### Field of the Invention

The present disclosure relates to the eyewear and eyewear systems having lenses that are easily replaceable by a user without the need for tools.

### Description of the Related Art

In traditional eyewear lenses are permanently fixed in the frame. This makes it inconvenient to replace lenses and, in many cases, new eyewear must be purchased when lenses are damaged or a new diopter is necessary. Even in the best of cases, replacement of lenses must be handled by professionals, which is inconvenient for users as they wait for repairs to be completed. There is therefore a need in the art for an eyewear system that allows the user to conveniently and easily, without the need for tools, replace the lenses of eyewear, in order to address the wasteful and excessively costly state of the art.

Additionally, traditional non-prescription reading glasses tend to be offered in a finite number of standard diopters, and with the same diopter in both eyes. However, some users May require different diopters in each eye or a diopter that is between standard offerings. There is therefore a need in the art for an eyewear system that allows a user to easily select and replace lenses with different diopters, and permits manufacturers to offer a range of different diopters in a cost-effective manner.

### SUMMARY OF THE INVENTION

In one aspect, the present invention solves these and other needs in the art by providing an eyewear system that includes a base configured to be used with lens inserts that the user selects and can install and/or replace at will. To this end, any number of retention mechanisms for securely, but releasably, retaining the lens inserts within the base may be employed, and may include, but is certainly not limited to, magnets, press fit, friction fit, interference fit, tabs and slots, ramps and cliffs, elastic deformation, hook and loop, temporary adhesives, and the like.

In one embodiment, the base is formed in the shape of eyewear frames, including at least lens rims and a nose bridge, but without lenses. In a preferred embodiment, and one in which the visual appeal of the eyewear system is enhanced, the base is formed with a relatively thin front face and sidewalls, but a hollow or recessed rear face. The lens inserts are dimensioned and configured to fit snuggly within the recess, which gives the appearance of a unitary construction.

Of course, more complex structures may be desired, either to enhance the ease with which lens inserts may be replaced, or also possibly to imbue the eyewear system with features that are considered “premium.” By way of non-limiting example, magnets may be used to retain the lens inserts in the base. While magnets may add cost to the production of the eyewear system, they are generally considered a feature of “premium” goods, and therefore, any eyewear system that incorporates magnets can support a higher market price.

In one embodiment of the present invention the eyewear system includes a base and lens inserts that have at least one magnet (the term magnet should henceforth be considered to encompass both magnets and ferromagnetic material as one of ordinary skill would understand that only one of each is necessary-two magnets are not required) and at least one mechanical retention feature. The base includes a magnet and a mechanical retention feature in alignment with the same features of the lens inserts. For example, the base may include a positioning slot on the interior of a lens rim and a magnet located near the temple bar hinge. The lens insert may include a subframe which retains the lens and includes structural features to facilitate retention. The subframe may include a positioning tab which corresponds to the positioning slot as well as magnet which corresponds to the magnet in the base. To install, a user first aligns the positioning tab in the positioning slot and then allows the magnetic attraction to secure the lens insert against the base.

In further embodiments, the base may also include one or more bosses, particularly where the base is recessed. In such an embodiment, the thickness of the base may be too thin to securely fasten other elements to it, such as temple bars, hinges, or nose pads. Bosses can provide additional material thickness to secure such items. Additionally, magnets may be at least partially embedded in a boss.

In another embodiment, the lens insert may also include an alignment ring that projects from the front end of the lens insert and encircles the lens. When installed in the base, an outer surface of the convex ring abuts the lens rim of the base and helps to align the lens insert within the base.

Another example of the present invention involves simpler structures so that cost efficiencies can be recognized in the manufacturing process, thereby providing the option to provide a “budget” eyewear system. By way of non-limiting example, the retention mechanism may be mechanical and integrated into the subframe of the lens insert, rather than relying on magnets. In particular, the subframe of the lens insert may include a plurality of retention tabs protruding therefrom. The retention tabs are dimensioned and configured to be received by retention pockets in the base. In a preferred embodiment, the strength and elasticity of the base is determined (with reference to material strength and thickness) such that the base can deform elastically as the lens insert is installed, and return to a non-stressed state once the retention tabs are situated in the retention pockets.

In yet further embodiments, the subframe may be made unitarily with the lens, such as by overmolding a polymer lens. The subframe may even be made of the same material as the lens and simply extend around the periphery of the lens.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a front perspective view of one embodiment of the inventive eyewear system showing lens inserts installed in a base.

FIG. 2 is a rear view of a lens insert according to one embodiment of the present invention.

FIG. 3 is a rear perspective view of a base without lens inserts according to one embodiment of the present invention.

FIG. 4 is a perspective view of a temple wire assembly according to one embodiment of the present invention.

FIG. 5 is a front view of a lens insert according to one embodiment of the present invention.

FIG. 6 is a rear perspective view of a base without lens inserts showing one embodiment of a positioning slot.

FIG. 7 is a front perspective view of a base without one temple bar in accordance with one embodiment of the present invention.

FIG. 8A is a rear perspective view of an eyewear system with one temple bar removed according to one embodiment of the present invention.

FIG. 8B is a rear perspective view of an eyewear system with one temple bar removed and one lens insert uninstalled according to one embodiment of the present invention.

FIG. 8C is a rear perspective view of an eyewear system with one temple bar removed and both lens inserts uninstalled according to one embodiment of the present invention.

FIG. 9 is a front perspective view of an eyewear system and a plurality of lens inserts according to one embodiment of the present invention

Like reference numerals refer to like parts throughout the several views of the drawings.

### DETAILED DESCRIPTION OF THE PREFERRED EMBODIMENT

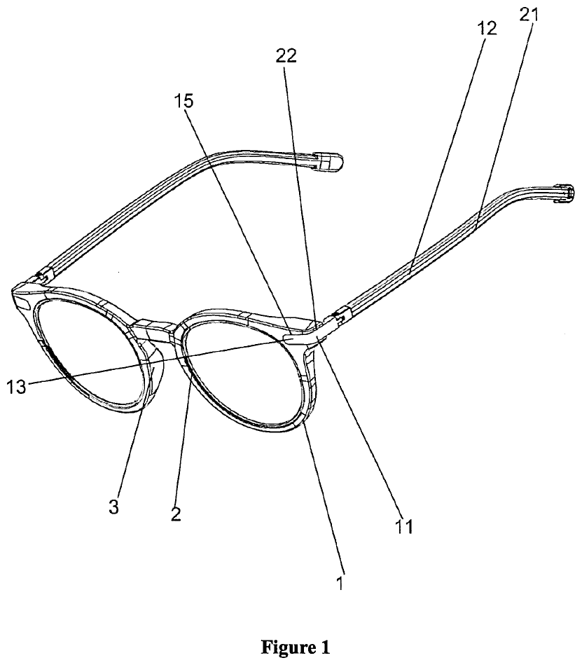

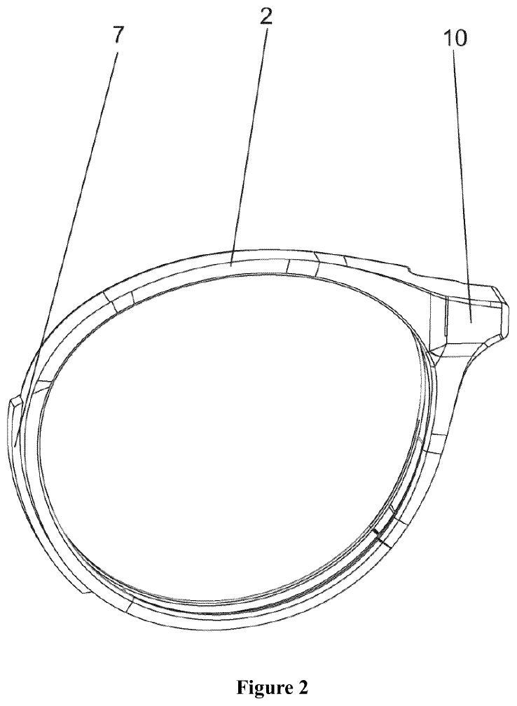

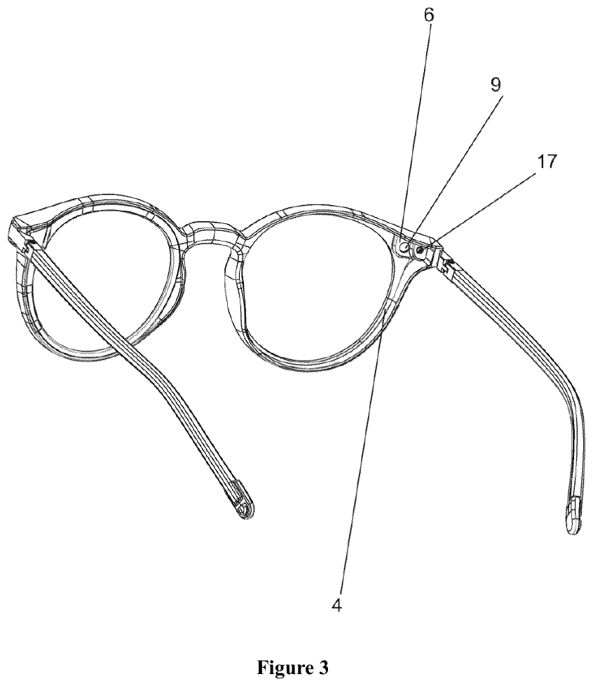

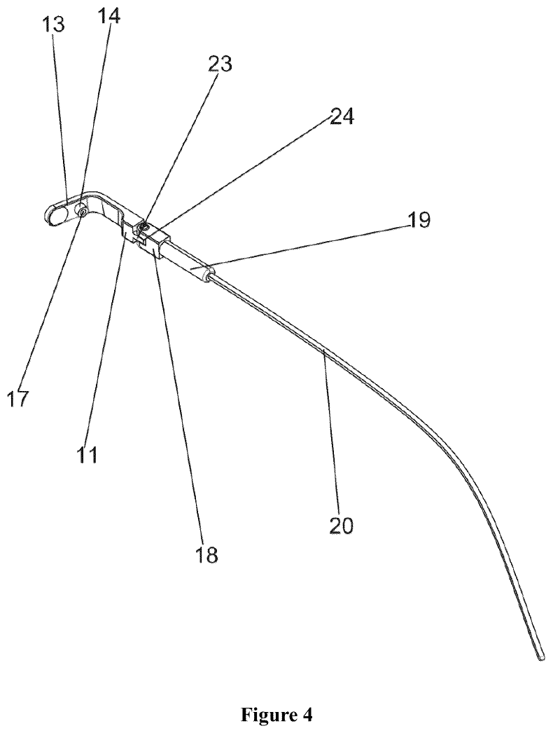

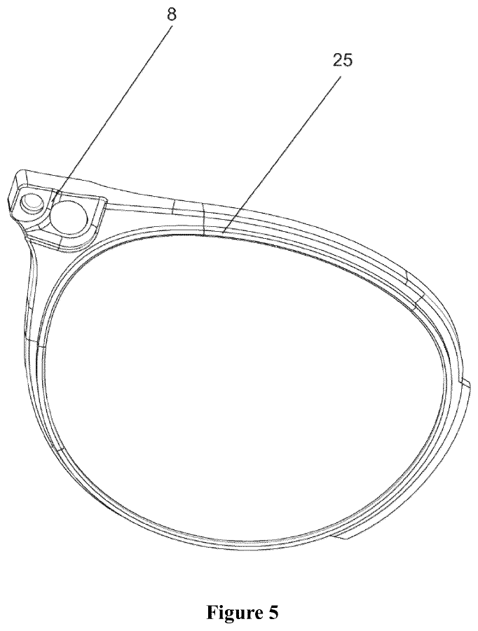

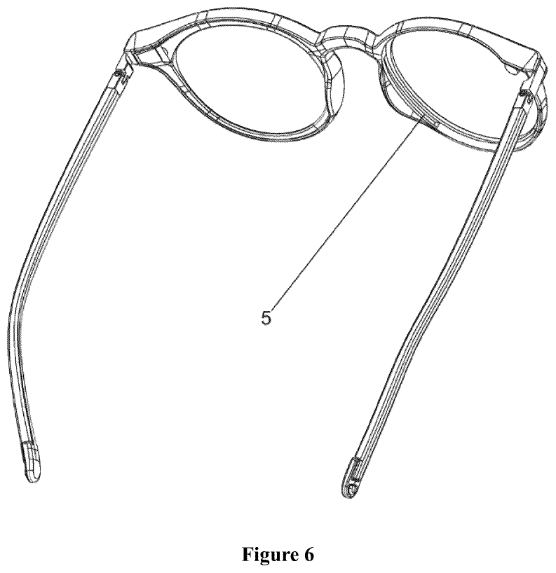

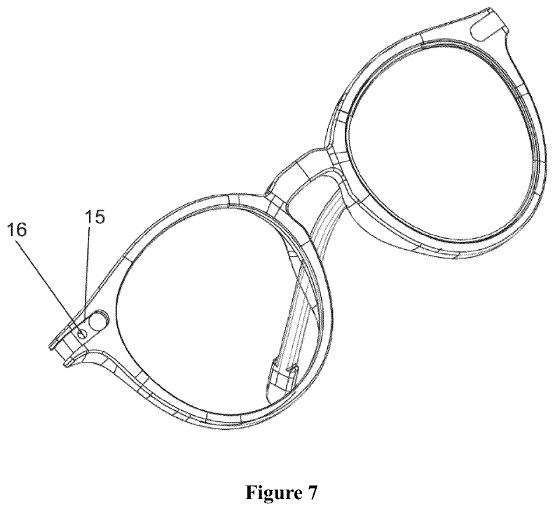

With reference to FIGS. 1-7, the depicted embodiment of includes eyewear comprising a base 1, a pair of lens inserts 2 mounted in the base 1 and a nose bridge 3 fixedly disposed on the base 1. The base 1 also includes lens rims 4 to receive the lens inserts 2. The lens rims 4 may also include a positioning slot 5 on at least one side, which is dimensioned and configured to receive a positioning tab 7 that protrudes from the lens insert 2. A boss 6 is located near the exterior profile of the lens rims 4 where an end lug 11 may be fixed to the base 1. When installed, the front surfaces of the lens inserts 2 will be in abutment with the rear surfaces of the lens rims 4 respectively. One side of each of the lens inserts 2 includes a positioning tab 7 that protrudes from the lens insert 2 and corresponds dimensionally to be received by the positioning slot 5. The lens insert 2 may also include an indentation 8 on the front surface that corresponds dimensionally to receive the boss 6.

In further embodiments, ferromagnetic material 9 is disposed within the boss 6 and the lens insert 2 includes a magnet 10 to attract the ferromagnetic material 9. Of course, this arrangement may be swapped (with the magnet located in the boss and the ferromagnetic material in the lens insert) or both components may simply include a magnet.

It will be appreciated now that the lenses are disposed within the lens inserts 2 and to replace the lens, it is only necessary to remove the existing lens insert 2 and insert another lens insert 2 with a new lens to the base 1. In this regard, changes to lenses are easily achieved by end users, without the need for tools or significant disassembly of the spectacles. The fixation, disassembly, and assembly of the lens insert and the base are made convenient via magnetic attraction at one end of the lens insert 2 and the mechanical fitment between the positioning tab 7 and the positioning slot 5 at another end thereof. For disassembly, the magnetically attracted end is first separated, followed by a slight pivot or rotation of the lens insert 2 to withdraw the positioning tab 7 from the positioning slot 5. For assembly, the positioning tab 7 is first placed in the positioning slot 5, followed by fixing the magnetically attracted end.

In further embodiments, the temple bars 12 include end lugs 11, which are fastened to the base 1. Connecting the end lugs 11 with the base 12 by means of fastening assemblies is convenient for replacing the end lugs 11 and temples 12 in their entirety.

In yet further embodiments, each of the fastening assemblies includes a retainer bar 13 fixedly disposed at the front end of the end lug 11 and bent towards the nose bridge 3. The retainer bar 13 may include a post 14 fixedly disposed and projecting from the retainer bar 13. Each side of the base 1 includes a retaining slot 15 that matches the respective retainer bar 13. In this configuration, the retainer bar 13 can be mounted flush with the front surface of the base 1. The bosses 6 include an alignment aperture 16 disposed therein and dimensioned to receive the respective post 14. The post 14 may also include a threaded aperture 17, with which the post 14 may be fastened to the boss 6 by means of a fastener. The fastener head of the screw is located at the rear end of the boss 6. When replacing the end lug 11 and/or temple 12, the respective lens insert 2 is first separated from the base 1, followed by loosening of the fastener.

In yet another embodiment, each of the temples 12 includes a connecting block 18 hingedly connected to the respective end lug 11. A cylindrical post 19 is fixed at the rear end of the connecting block 18 and a temple wire 20 is fixed at the rear end of the cylindrical post 19. The temple wire 20 has a radius smaller than that of the cylindrical post 19. An ear piece 21 is sheathed on the temple wire 20 and the cylindrical post 19.

In yet another embodiment, a male hinge member 23 is fixed at the rear end of the end lug 11 and a female hinge member 24 is located on the end of the connecting block 18. A fastener may then be used as a pin to secure the male hinge member 23 and female hinge member 24 in hinging relationship to one another.

In yet another embodiment, the lens insert 2 includes an alignment ring 25 protruding from the front end of the lens insert 2 and encircling the lens. When installed on the base 1, the alignment ring 25 abuts the inner perimeter loop of the base 1. The alignment ring 25 facilitates the connection and proper alignment between the lens insert 2 and the base 1.

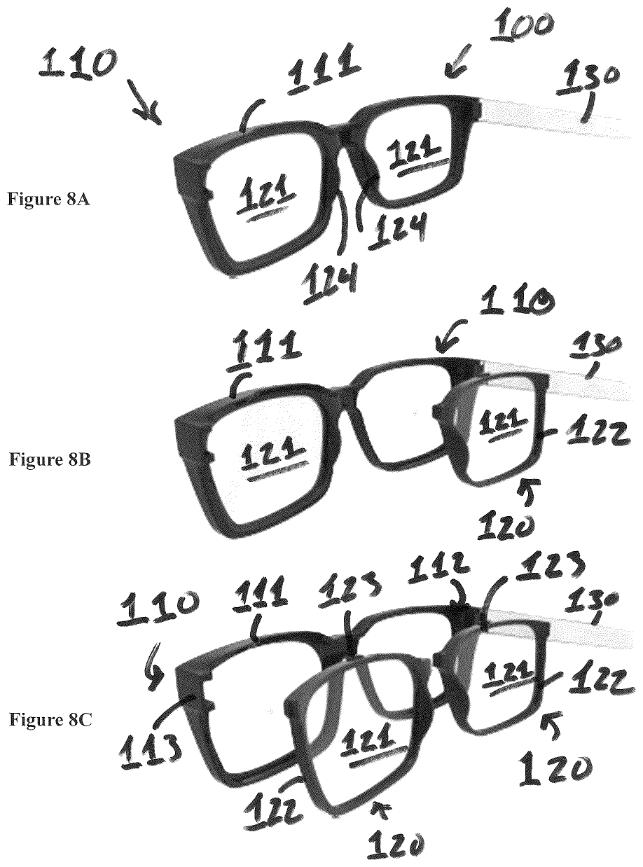

Turning to FIG. 8, another embodiment of the eyewear system 100 is disclosed. In the depicted embodiment, the base 110 is open on its rear face, being constructed from a front face and rearwardly projecting sidewall, which forms a recess 112 or open rear face running along the periphery of the lens rim 111, as well as across the nose bridge. The lens inserts 120 are chiral, having left and right configurations, and are configured to fit within at least a portion of the base 110.

The lens inserts 120 may further include lenses 121 held within subframes 122. The subframes may include a plurality of retention tabs 123 projecting from their periphery. The retention tabs 123 are dimensioned and configured to nestle within retention recesses inside the base 110, and can take advantage of an interference fit in order to ensure that the subframes 122 are securely held within the base 110, but also removable by hand. Also, in the depicted embodiment, the nose pads 124 are disposed on the subframes 122. The subframes 122 may also include other features such as projections dimensioned and configured to fit at least partially within the nose bridge, which help the user orient the lens insert 121 when installing.

In a preferred embodiment, the subframes 122 are dimensioned to sit flush within the recess 112 of the base to provide a quality fit and finish, and further give the appearance of a unitary eyewear frame. The depicted embodiment of FIG. 8 also takes advantage of a simpler hinge design, having the components formed directly into the base 110 and temple bar 130.

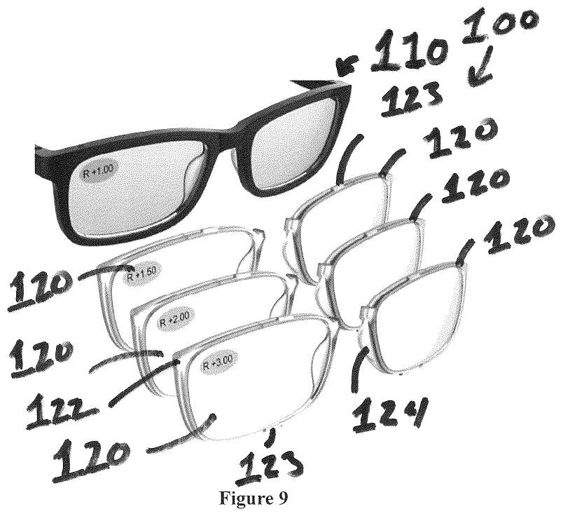

The embodiment of FIG. 9 provides a cost-effective alternative design of the lens inserts 120′. In the depicted embodiment, the subframes 122′ are formed unitarily with the lenses 121. The subframe 122′ can be incorporated into the lens blank (for molded lenses) and protrude from the periphery of the lens, being formed from the same material as the lens.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. An eyewear system comprising:
at least a base and a plurality of lens inserts;
said base including two lens rims;
and said plurality of lens inserts each dimensioned and configured to be releasably mounted within corresponding ones of said plurality of lens rims.

2. The eyewear system as recited in claim 1 wherein said base further comprises at least one retention pocket; each of said lens inserts further comprising at least one retention tab protruding therefrom.

3. The eyewear system as recited in claim 1 wherein said base is formed with a recess in a rear face of said base.

4. The eyewear system as recited in claim 3 wherein said recess at least partially encircles said lens rims.

5. The eyewear system as recited in claim 4 wherein each of said plurality of lens inserts are dimensioned and configured to align with a corresponding portion of said recess.

6. The eyewear system as recited in claim 1 wherein said base is comprised of a front face, a sidewall at least partially encircling said front face, and an open rear face.

7. The eyewear system as recited in claim 6 wherein said sidewall extends rearwardly from said front face and at least partially defines a recess.

8. The eyewear system as recited in claim 1 wherein each of said lens inserts further comprises a lens held within a subframe.

9. The eyewear system as recited in claim 1 wherein each of said lens inserts further comprise a subframe encircling a lens.

10. The eyewear system as recited in claim 1 wherein each of said lens inserts further comprises a nose pad.

11. An eyewear system base comprising:
a front surface and a sidewall at least partially encircling said front surface;
said sidewall protruding rearward from said front surface and at least partially defining at least one recess in a rear face of the eyewear system base;
said recess being dimensioned and configured to accommodate a plurality of lens inserts.

12. The eyewear system base as recited in claim 11 further comprising a plurality of retention pockets formed within said recess, said plurality of retention pockets dimensioned and configured to receive at least one retention tab protruding from said lens insert.

13. The eyewear system base as recited in claim 11 wherein the base further includes a plurality of lens rims; wherein said recess encircles each of said plurality of lens rims.

14. An eyewear system lens insert comprising:
a lens at least partially encircled by a subframe;
said subframe being dimensioned and configured to be mounted on a base;
at least one retention tab protruding from said subframe.

15. The eyewear system lens insert as recited in claim 14 wherein said lens is held within said subframe.

16. The eyewear system lens insert as recited in claim 14 wherein said subframe is formed unitarily with said lens.

17. The eyewear system lens insert as recited in claim 14 wherein said subframe further comprises a nose pad.
